(19) United States
(12) Patent Application Publication
(10) Pub. No.: US 2013/0300855 A1
(43) Pub. Date: Nov. 14, 2013

(54) SYSTEM AND METHOD FOR PERFORMING AN INTERNAL INSPECTION ON A WIND TURBINE ROTOR BLADE

(71) Applicants: Peter James Fritz, Williamston, MI (US); Kevin George Harding, Niskayuna, NY (US); Guiju Song, Shanghai (CN); Yong Yang, Shanghai (CN); Li Tao, Shanghai (CN); Xinjun Wan, Shanghai (CN)

(72) Inventors: Peter James Fritz, Williamston, MI (US); Kevin George Harding, Niskayuna, NY (US); Guiju Song, Shanghai (CN); Yong Yang, Shanghai (CN); Li Tao, Shanghai (CN); Xinjun Wan, Shanghai (CN)

(21) Appl. No.: 13/980,345

(22) PCT Filed: Jan. 21, 2011
(86) PCT No.: PCT/CN2011/000098

§ 371 Date: Jul. 18, 2013

(51) Int. Cl. H04N 7/18

(52) U.S. Cl. CPC H04N 7/18
USPC 348/82

(57) ABSTRACT

A system (200) and method for performing an internal inspection on a rotor blade (16) of a wind turbine are disclosed. The system includes a sensing device (202), a cable (210) for raising and lowering the sensing device within the rotor blade, and a positioning device (206) attached to at least one of the sensing device and the cable. The positioning device can be configured to space the sensing device apart from an interior surface (208) of the rotor blade as the sensing device is raised and lowered within the rotor blade.

### FIELD OF THE INVENTION

The present subject matter relates generally to wind turbines and, more particularly, to a system and method for performing an internal inspection on a wind turbine rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

The maintenance of wind turbine components is critical to the ongoing operation of a wind turbine. Thus, maintenance operations, such as inspections, are routinely performed on wind turbine rotor blades to ensure that they are in optimal operating condition. For example, visual inspections of the interior of a rotor blade may be performed to identify cracks, debonding issues and other potential defects. To perform such visual inspections, conventional methods typically require that an operator enter the internal cavities of the blade, which can be very dangerous. Other known internal inspection methods include the use of a robotic crawler configured to traverse the interior of the rotor blade. However, the expense of such robotic crawlers generally prohibits their widespread use.

Accordingly, there is a need for a safe and low cost system for performing an internal inspection on a wind turbine rotor blade.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a system for performing an internal inspection on a rotor blade of a wind turbine. The system may generally include a sensing device and a cable for raising and lowering the sensing device within the rotor blade. The system may also include a positioning device attached to at least one of the sensing device and the cable. The positioning device may generally be configured to space the sensing device apart from an interior surface of the rotor blade as the sensing device is raised and lowered within the rotor blade.

In another aspect, the present subject matter discloses a method for performing an internal inspection on a rotor blade. The method may generally include coupling a sensing device to a cable, lowering the sensing device within the rotor blade and maintaining the sensing device spaced apart from an interior surface of the rotor blade as the sensing device is moved within the rotor blade.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine of conventional construction;

FIG. 2 illustrates a perspective view of one embodiment of a system for performing an internal inspection on a wind turbine rotor blade in accordance with aspects of the present subject matter;

FIG. 3 illustrates a partial, perspective view of a portion of the system shown in FIG. 2; and,

FIG. 4 illustrates a perspective view of another embodiment of a system for performing an internal inspection on a wind turbine rotor blade in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter discloses a system for performing an internal inspection on a rotor blade. For example, in several embodiments, a system is disclosed having one or more sensing devices coupled to a cable for raising and lowering the sensing device(s) within the rotor blade. The system may also include a positioning device configured to space the sensing device(s) apart from an interior surface of the rotor blade as it is raised and lowered within the blade.

As used herein, the term “inspection” refers to any operation, action and/or test performed on a wind turbine that is designed to monitor, sense, locate, measure and/or detect a condition of any component of the wind turbine and, particularly, a condition of a rotor blade of the wind turbine. For example, inspections may include, but are not limited to, visual inspections of the interior of the rotor blades, optical nondestructive evaluation (NDE) tests (e.g., shearography tests), thermography tests and other related operations/tests. Additionally, the term “sensing device” may refer to any suitable sensor, equipment, mechanism and/or any other item that may be utilized to monitor, sense, located, measure and/or detect the condition of a component of a wind turbine. Thus, sensing devices may include, but are not limited to, visual cameras, infrared cameras, ultraviolet cameras, video cameras, other suitable cameras, ultrasonic detectors, x-ray detectors, other suitable imaging devices and sensors, light sources (e.g., a light-emitting diode (LED) array), proximity sensors, position sensors, displacement sensors, linear encoders, measurement devices, laser scaling devices, magnetic sensing equipment, ultrasound equipment, microwave instrumentation, active infrared equipment, optical NDE testing equipment, thermography testing equipment and any other suitable equipment, sensors, mechanisms and/or items.

Thus, in several embodiments, the system of the present subject matter may be configured to perform an internal visual inspection on a wind turbine rotor blade. For example, it may be desirable to visually inspect the internal cavities of the rotor blade for anomalies, such as debonding issues, cracks and other defects. Accordingly, in such embodiments, the disclosed sensing device(s) may comprise one or more suitable optical and/or imaging devices configured to monitor, locate, sense, measure and/or detect such anomalies. For instance, in a particular embodiment of the present subject matter, the sensing device(s) may comprise one or more remote controlled pan tilt zoom (PTZ) cameras configured to capture images of the interior of a rotor blade.

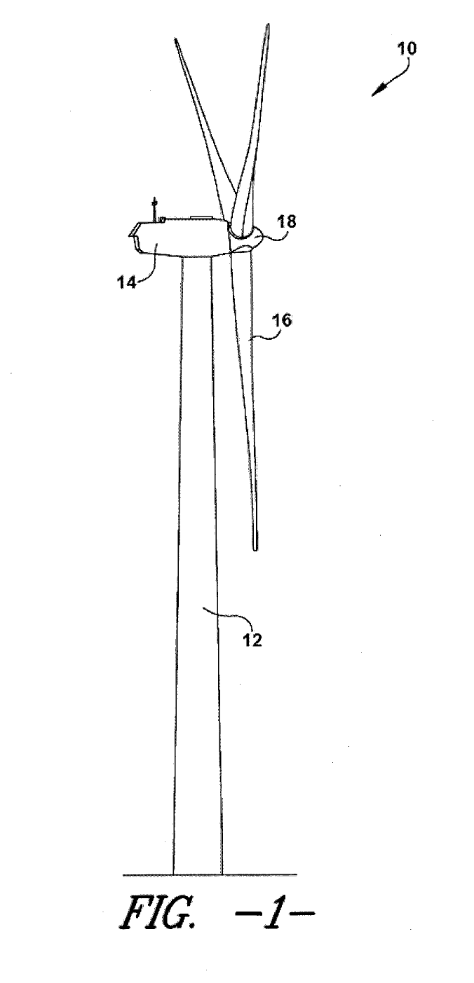

Referring now to the drawings, FIG. 1 illustrates a wind turbine 10 of conventional construction. The wind turbine 10 generally includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. The wind turbine 10 of FIG. 1 is generally provided for illustrative purposes only to place the present subject matter in an exemplary field of use. Thus, it should be appreciated that the present subject matter is not limited to any particular type of wind turbine configuration.

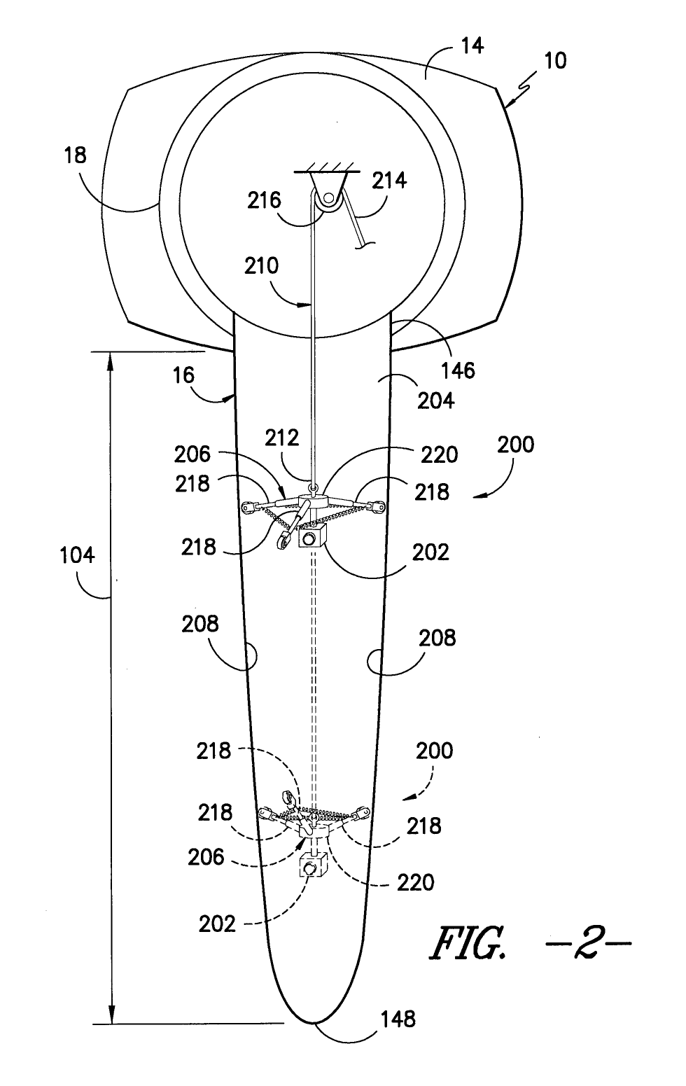

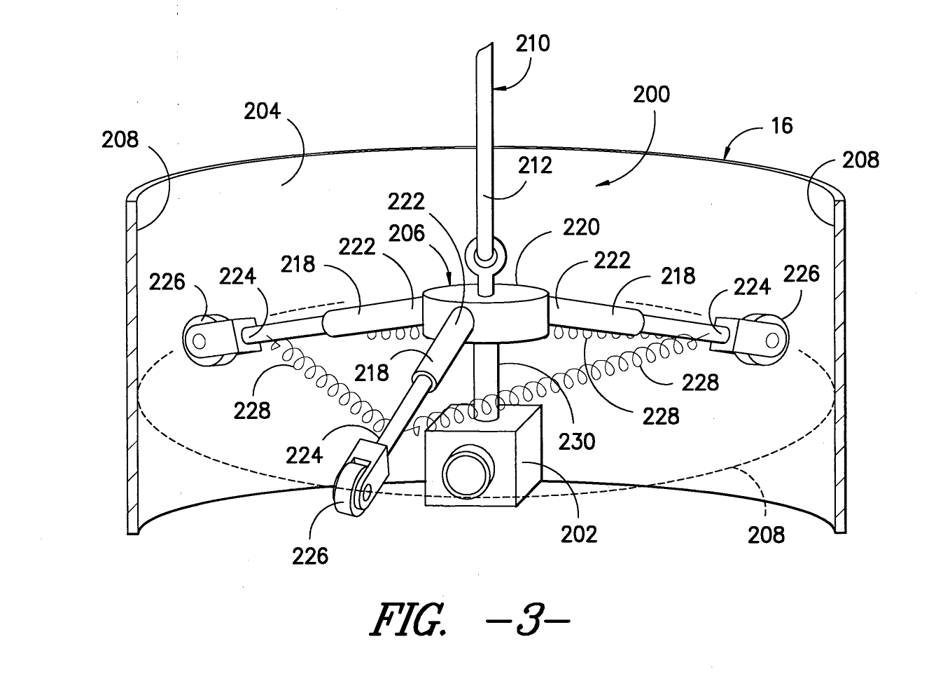

Referring now to FIGS. 2 and 3, there is illustrated one embodiment of a system 200 for performing an internal inspection of a rotor blade 16 of a wind turbine 10. In particular, FIG. 2 illustrates a perspective view of one embodiment of the system disposed within the rotor blade 16 and the hub 18 of a wind turbine 10 in accordance with aspects of the present subject matter. Additionally, FIG. 3 illustrates a perspective view of a portion of the system shown in FIG. 2.

In general, the system 200 may include one or more sensing devices 202 configured to be raised and lowered within a rotor blade 16, such as within an internal cavity 204 of the rotor blade 16, to permit an internal inspection of the blade 16 to be performed. Additionally, the system 200 may include a positioning device 206 configured to space the sensing device(s) 202 apart from one or more interior surfaces 208 of the rotor blade 16. As such, the relative positioning of the sensing device(s) 202 with respect to the interior surfaces 208 may be maintained as the sensing device(s) 202 is raised and lowered within the rotor blade 16. It should be appreciated that, as used herein, the term “interior surface” may refer to any interior surface or wall of the rotor blade 16, including the interior surfaces/walls of the blade shell and any interior surfaces/walls of internal rotor blade components (e.g., spar caps, shear webs and the like). Additionally, the term “internal cavity” refers to any internal space or volume defined within the rotor blade 16.

As particularly shown in FIG. 2, in several embodiments of the present subject matter, the disclosed system 200 may also include a cable 210 configured to be displaced vertically so as to raise and lower one or more of the sensing devices 202 within the rotor blade 16. Thus, the cable 210 may generally include a first end 212 configured to be coupled to the sensing device(s) 202, such as by being directly attached to the sensing device(s) 202 or by being indirectly attached to the sensing device(s) 202 through the positioning device 206. Additionally, the cable 210 may include a second end 214 configured to be disposed at location within the wind turbine hub 18. Thus, in several embodiments, the second end 214 of the cable 210 may be coupled to a pulley mechanism 216 positioned within the hub 18 to that allow the sensing device(s) 202 to be raised and lowered within the rotor blade 16 in a controlled manner. In general, the pulley mechanism 216 may comprise any suitable mechanism configured to provide a means for controlling the displacement of the cable 210. For example, the pulley mechanism 216 may comprise a pulley, a manual or automatic winch or any other similar lifting device. In other embodiments, it should be appreciated that the cable 202 need not be coupled to a pulley mechanism 216. For example, an operator located within the wind turbine hub 18 may simply raise and lower the sensing device(s) 202 by hand.

It should be appreciated that, in alternative embodiments, the sensing device(s) 202 may be configured to be raised and lowered within the rotor blade 16 using any other suitable means. For example, in one embodiment, an elongated pole, a telescoping rod or any other suitable device may be utilized to move the sensing device(s) 202 up and down within the rotor blade 16.

As indicated above, the positioning device 206 of the disclosed system 200 may generally be configured to space the sensing device(s) 202 apart from the interior surfaces 208 of the rotor blade 16 as the sensing device(s) 202 is raised and lowered within the blade 16. For example, the positioning device 206 may be configured to maintain the sensing device(s) 202 at a central location within the internal cavity 204 within which the sensing device(s) 202 is being raised or lowered. Additionally, the positioning device 206 may also serve to stabilize the sensing device(s) 202 within the rotor blade 16. In particular, the positioning device 206 may be configured to steadily guide the sensing device(s) 202 between the interior surfaces 208 of the rotor blade 16 as the sensing device(s) 202 is raised and lowered.

Thus, in several embodiments of the present subject matter, the positioning device 206 may include a plurality of outwardly extending legs 218 configured to contact the interior surfaces 208 of the rotor blade 16. For example, as shown in the illustrated embodiment, the positioning device 206 may have a tripod-like configuration and may include three legs 218 extending outwardly from a base 220. Each leg 218 may generally extend between a first end 222 configured to be attached to the base 220 and a second end 224 configured to contact an interior surface 208 of the rotor blade 16. As such, the legs 218 of the positioning device 206 may generally provide a self-centering effect to the sensing device(s) 202 as it is moved within the rotor blade 16. It should be appreciated that, in alternative embodiments, the positioning device 206 may generally include any number of legs 218 extending outwardly from the blade 16, such as fewer than three legs 218 or greater than three legs 218.

In general, the base 220 of the positioning device 206 may be configured to support the legs 218 within the rotor blade 16. Thus, the first end 222 of each leg 218 may generally be configured to be attached to the base 220 using any suitable means. For example, in several embodiments of the present subject matter, the first end 222 of each leg 218 may be configured to be pivotally attached to the base 220, such as by using any suitable hinged and/or pivotal attachment mechanism. As such, the legs 218 may generally be configured to rotate or pivot about the base 220 to account for the variation in size of the rotor blade 16 between the blade root 146 and the blade tip 148. In particular, as shown in dashed lines in FIG. 2, the contact between the second end 224 of each leg 218 and the interior surfaces 208 of the rotor blade 16 may cause the legs 218 to rotate upward about the base 220 as the positioning device 206 is moved in the direction of the blade tip 148. Such upward rotation of the legs 218 may generally allow the positioning device 206 and, thus, the sensing device(s) 202 to be lowered within the rotor blade 16 to position generally adjacent the blade tip 148. Similarly, as the positioning device 206 is moved in the direction of the blade root 146, the legs 218 may be configured to rotate downward about the base 220 to permit the legs 218 to spread out within the increasing size of the internal cavity 204 and, thus, ensure that the second ends 224 of the legs 218 remain in contact with the interior surfaces 208 of the rotor blade 16.

Additionally, the second end 224 of each leg 218 may generally be configured to rub/slide against or otherwise engage the interior surfaces 208 of the rotor blade 16 to allow the sensing device(s) 202 to be properly positioned and/or stabilized as it is raised and lowered within the blade 16. Thus, in several embodiments, the second ends 224 of the legs 218 may include a contact feature configured to reduce friction at the interface between the ends 224 and the interior surfaces 208. For example, in one embodiment, a rubber guide/pad and/or any other flexible member may be attached to the second ends 224 of the legs 218 to provide a smooth and/or flexible, low-friction interface. Alternatively, as shown in the illustrated embodiment, a roller 226 (e.g., a wheel, caster and/or any other suitable rolling mechanism) may be disposed at the second end 224 of each leg 218 to permit the end 224 to roll against an interior surface 208 of the rotor blade 16 and, thus, provide a low friction interface between the legs 218 and the interior surface 208. It should be appreciated that such a low-friction interface may assist the legs 218 in rotating about the base 220 as the sensing device(s) 202 is moved between the blade root 146 and the blade tip 148.

Moreover, as shown in the illustrated embodiment, one or more tensioning devices 228 may be coupled between each of the legs 218. In general, the tensioning devices 228 may be configured to bias the legs 218 outwardly against the interior surfaces 208 of the rotor blade 16 and, thus, may provide a means for maintaining the legs 218 in contact with the interior surfaces 208 as the sensing device(s) 202 is raised and lowered within the blade 16. As such, the tensioning devices 228 may also assist in centering the sensing device(s) 202 within the rotor blade 16. As shown, in one embodiment, the tensioning devices 228 may comprise springs secured between each of the legs 218. However, in other embodiments, the tensioning devices 228 may comprise any other suitable devices and/or items capable of providing a biasing or tensioning force between the legs 218.

Moreover, in several embodiments of the present subject matter, the legs 218 may include telescoping features to allow the length of each leg 218 to be adjustable. Thus, in one embodiment, the legs 218 may include a spring loaded telescoping feature configured to bias the legs 218 outwardly towards the interior surfaces 208 of the rotor blade 16. For example, the legs 218 may be formed from two or more spring loaded, telescoping cylinders. It should be appreciated that such a spring loaded feature may be particularly advantageous in embodiments in which the legs 218 are pivotally attached to the base 220. In particular, the spring loaded feature may prevent the positioning device 206 from becoming stuck within the rotor blade 16 as the legs rotate about the base 220 past a horizontal position (e.g., at an angle generally perpendicular to the longitudinal direction of the cable 210).

Additionally, it should be appreciated that the legs 218 may generally be formed from any suitable material. For example, in several embodiments of the present subject matter, the legs 218 may be formed from a rigid material, such as various different metals, plastics and/or any other suitable rigid materials. Alternatively, the legs 218 may be formed from a flexible or semi-rigid material that allows the legs 218 to bow or flex as they move along the interior surfaces of the rotor blade 16. Such bowing or flexing may generally provide a natural spring force through the legs 218 that biases the legs 218 outwardly against the interior surfaces 208 of the rotor blade 16. Additionally, the ability to bow or flex may provide a means for removing the disclosed system 200 from a rotor blade 16 in the event that a component of the system 200 becomes stuck behind a cross-member, gusset, shear web or similar obstruction within the blade 16. Thus, in one embodiment of the present subject matter, the legs 218 may be formed from a lightweight, foam material, such as polyethylene foams, polystyrene foams, urethane foams and/or any other suitable closed-cell or open-cell foam material. However, in other embodiments, the legs 218 may be formed from any other suitable flexible or semi-rigid material.

It should be appreciated that, in addition to supporting the legs 218, the base 220 of the positioning device 206 may also serve as an attachment mechanism for attaching the sensing device(s) 202 to the cable 210. For example, as shown in the illustrated embodiment, the base 220 may be attached directly to the first end 212 of the cable 210. In such an embodiment, the sensing device 202 may generally be configured to be mounted to a portion of the base 220, such as by being attached to the opposing side of the base 220 and/or by being coupled to the base 220 through a separate mounting plate and/or other mounting device 230 disposed between the sensing device 202 and the base 220. In other embodiments, the positioning device 206 may be configured to be disposed below the sensing device 202. As such, the sensing device 202 may be directly attached to the cable 210, with the positioning device 206 being directly or indirectly coupled to a portion of the sensing device 202.

It should also be appreciated that, in alternative embodiments of the present subject matter, the positioning device 206 need not include the above described base 220. For example, the legs 218 of the positioning device 206 may be attached directly to the cable 210 and/or the sensing device 202.

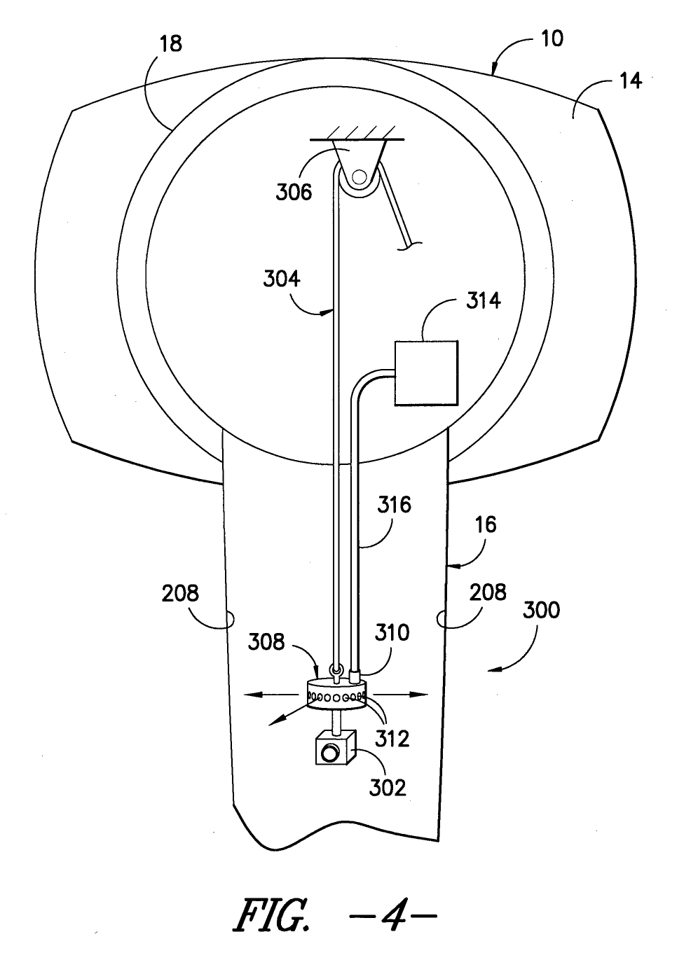

Referring now to FIG. 4, there is illustrated another embodiment of a system 300 for performing an internal inspection on a rotor blade 16 of a wind turbine 10. In general, the illustrated system 300 may be configured similarly to the system 200 described above with reference to FIGS. 2 and 3 and may include many and/or all of the same feature and/or components. Thus, the system 300 may generally include one or more sensing devices 302 and a cable 304 configured to raise and lower the sensing device(s) 302 within the rotor blade 16. For example, the cable 302 may be configured to extend from generally adjacent the sensing device(s) 302 to a location within the wind turbine hub 18, such as by being coupled to a pulley mechanism 306 disposed within the hub 18. Additionally, the system 300 may include a positioning device 308 configured to space the sensing device(s) 302 apart from one or more interior surfaces 208 of the rotor blade 16. As such, the relative position of the sensing device(s) 302 with respect to the interior surfaces 208 may be maintained as the sensing device(s) 302 is raised and lowered within the rotor blade 16.

However, unlike the system 200 described above, the positioning device 308 may be configured to control the position of the sensing device(s) 302 within the rotor blade 16 by expelling a pressurized fluid (e.g., air or any other suitable fluid) against the interior surfaces 208 of the blade 16. For example, in several embodiments, the positioning device 308 may comprise any suitable member having one or more inlets 310 for receiving a pressurized fluid and one or more outlets 312 from expelling the pressurized fluid against the interior surfaces 208 of the rotor blade 16. Thus, in the illustrated embodiment, the positioning device 308 may define an inlet 310 configured to be in fluid communication with a pressurized fluid source 314. For instance, as shown, an air hose or other suitable fluid line 316 may be coupled between the inlet 310 and an air compressor or other pressurized fluid source 314 disposed within the wind turbine hub 18 to permit a pressurized fluid to be supplied to the positioning device 308. In such an embodiment, it should be appreciated that the air hose or other fluid line 316 may also serve as a replacement for the cable 304 and, thus, may be utilized to raise and lower the sensing device(s) 302 within the rotor blade 16.

Additionally, as shown, a plurality of fluid outlets 312 may be defined around the outer perimeter of the positioning device 308. In general, the outlets 312 may be configured to expel the fluid flowing through the positioning device 308 against the interior surfaces 208 of the rotor blade 16 so as to control location of the sensing device(s) 302 within the blade 16. Thus, in several embodiments, the diameter or other dimensions of the outlets 312 and/or the input pressure of the pressurized fluid may generally be chosen such that the pressurized fluid may be expelled from the positioning device 308 with a sufficient force to provide the desired positioning control.

It should be appreciated that, in alternative embodiments of the present subject matter, the systems 200, 300 described above with reference to FIGS. 2-4 need not include a positioning device 206, 308. For example, in one embodiment, the systems 200, 300 may simply comprise one or more sensing devices 202, 302 configured to be lowered into the interior of the rotor blade 16 with a cable 210, 304.

It should also be appreciated that, in several embodiments, the sensing device(s) 202, 302 disclosed herein may be configured to be communicatively coupled (e.g., through a wireless or wired connection) to a display device, processing equipment and/or any other suitable device (not shown) to allow images and/or other information captured by the sensing device(s) 202, 302 to be transmitted, viewed and/or recorded while the internal inspection is being performed. For example, the sensing device(s) 202, 302 may be communicatively coupled to a display device (e.g., a laptop or any other suitable equipment having a display screen) such that the operator performing the inspection may view the images and/or other information as it is captured by the sensing device(s) 202, 302. Thus, in the embodiments described above with reference to FIGS. 2-4, a display device may be located within the wind turbine hub 18 such that the operator may manipulate the position of the sensing device(s) 202, 302 within the rotor blade 16 (e.g., by raising and/or lowering the sensing device(s) 202, 302 using the cable 210, 304) based on the images and/or other information displayed on such display device.

Moreover, in further embodiments, one or more of the disclosed sensing devices 202, 302 may be communicatively coupled to a device controller and/or any other device that allows the sensing device(s) 202, 302 to be operated remotely through a wired or wireless connection. For instance, in a particular embodiment of the present subject matter, the sensing device(s) 202, 302 may comprise one or more remote controlled pan tilt zoom (PTZ) cameras. As is generally understood, PTZ cameras may be configured to rotate in various directions and zoom in and out to adjust the field of view of the camera. Thus, the operator performing the inspection may automatically adjust the orientation of the camera to allow various different images of the interior of the rotor blade 16 to be captured. Such a feature may be particularly advantageous in embodiments in which the operator is provided with a display screen for viewing the images and/or other information captured by the PTZ camera, as the orientation of the camera may be adjusted based on the images/information viewed on the display screen.

Additionally, in several embodiments, the sensing device(s) 202, 302 of the present subject matter may include a combination of optical equipment (e.g., one or more cameras) and one or more light sources configured to illuminate the areas of interest of the rotor blade 16. For example, in the embodiments described above with reference to FIGS. 2-4, one or more light sources may be attached to and/or built into the positioning device 206, 308, the optical equipment and/or any other suitable component of the system (e.g., the cable 210, 304) to enhance the ability of the optical equipment to capture images of the interior of the rotor blade 16. In general, it should be appreciated that any suitable light source may be utilized within the scope of the present subject matter. However, in a particular embodiment of the present subject matter, the light source may comprise a light-emitting diode (LED) array or other light source specifically configured to enhance the appearance of cracks and/or other surface defects of the rotor blade 16.

Further, in several embodiments, the sensing device(s) 202, 302 of the present subject matter may include one or more sensors and/or other mechanisms for detecting the location of the sensing device(s) 202, 302 and/or the positioning device 206, 308 relative to the interior surfaces of the rotor blade 16. For example, a proximity sensor or a similar sensor may be built into or mounted to one or more of the sensing device(s) 202, 302 and/or the positioning device 206, 308 to provide information regarding the proximity of the sensing device(s) 202, 302 and/or the positioning device 206, 308 relative to the interior surfaces of the rotor blade 16.

In embodiments in which the sensing device(s) 202, 302 are configured to capture images of the interior of the rotor blade 16, the sensing device(s) 202, 302 may also include one or more sensors and/or other mechanisms for determining the scale of the images captured by the sensing device(s) 202, 302. For example, in one embodiment, the sensing device(s) 202, 302 may comprise a combination of one or more cameras and one or more laser scaling devices. Each laser scaling device may be configured to project two or more laser beams of known spacing into the field of view of one or more of the cameras such that the size of cracks and other surface defects captured within the images may be accurately calculated.

Additionally, in further embodiments, one or more of the sensing devices 202, 302 of the present subject matter may comprise a means for detecting and/or determining the vertical position of another sensing device(s) 202, 302 and/or the positioning device 206, 308 along the span 104 of the rotor blade 16. As such, the spanwise locations of any defects detected by the sensing device(s) 202, 302 may be easily identified. For example, in one embodiment, one or more cables 210, 304 of the disclosed systems 200, 300 may be metered or marked to allow the vertical position of one or more sensing device(s) 202, 302 and/or the positioning device 206, 308 to be determined. In another embodiment, a suitable measurement device (e.g., a tape measure) may be coupled to one or more of the cables 210, 304. Alternatively, one or more of the sensing devices 202, 302 may comprise one or more linear encoders, position encoders and/or any other suitable linear measurement sensors. For example, in embodiments in which the cables 210, 304 are coupled through a pulley mechanism 216, 306 or other rotational lifting device, a linear encoder may be coupled to the mechanism/device to allow for the accurate determination of the linear displacement of the cable 210, 304. Similarly, a linear encoder may be coupled to one or more of the rollers 226 of the legs 218 described above with reference to FIGS. 2 and 3 to provide information regarding the position of the sensing device(s) 202 and/or the positioning device 206.

It should be appreciated that, as used herein, the term “cable” refers to any length of material which may be configured to function as described herein. As such, the cables 210, 304 of the present subject matter may include any suitable cables, wires, ropes, tapes, chains, hoses or lines formed from any suitable material. For example, in a particular embodiment, the disclosed cables 210, 304 may comprise one or more electrical cables for supplying power to the sensing device(s) 202, 302. In another embodiment, the cables 210, 304 may comprise air hoses or any other type of fluid line for supplying fluid to the positioning device 308.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for performing an internal inspection on a rotor blade of a wind turbine, the system comprising:
a sensing device;
a cable for raising and lowering said sensing device within the rotor blade; and
a positioning device attached to at least one of said sensing device and said cable, said positioning device being configured to space said sensing device apart from an interior surface of the rotor blade as said sensing device is raised and lowered within the rotor blade.

2. The system of claim 1, wherein said positioning device comprises a plurality of legs configured to contact the interior surface of the rotor blade.

3. The system of claim 2, wherein each of said plurality of legs includes a roller configured to contact the interior surface.

4. The system of claim 2, further comprising a tensioning device coupled between each of said plurality of legs.

5. The system of claim 2, wherein each of said plurality of legs includes telescoping features.

6. The system of claim 2, wherein each of said plurality of legs is formed from a flexible material.

7. The system of claim 2, wherein each of said plurality of legs is pivotally attached to a base.

8. The system of claim 7, wherein said base is attached to at least one of said sensing device and said cable.

9. The system of claim 2, wherein said plurality of legs is configured to maintain said sensing device in a central location within an internal cavity of the rotor blade.

10. The system of claim 1, wherein said sensing device comprises a pan tilt zoom camera.

11. The system of claim 1, further comprising a second sensing device, said second sensing device being configured to detect a location of at least one of said sensing device and said positioning device relative to the rotor blade.

12. The system of claim 1, wherein said positioning device is configured to expel a pressurized fluid against the interior surface of the rotor blade in order to space said sensing device apart from the interior surface.

13. The system of claim 12, wherein said positioning device defines an inlet configured to be in fluid communication with a pressurized fluid source.

14. The system of claim 12, wherein said positioning device defines a plurality of outlets configured to expel the pressurized fluid against the interior surface of the rotor blade.

15. A method for performing an internal inspection on a rotor blade, the method comprising:
coupling a sensing device to a cable;
lowering said sensing device within the rotor blade; and,
maintaining said sensing device spaced apart from an interior surface of the rotor blade as said sensing device is moved within the rotor blade.

16. The method of claim 15, wherein maintaining said sensing device spaced apart from the interior surface of the rotor blade comprises contacting the interior surface of the rotor blade with a plurality of legs.

17. The method of claim 15, wherein maintaining said sensing device spaced apart from the interior surface of the rotor blade comprises expelling a pressurized fluid against the interior surface.

18. The method of claim 15, further comprising detecting a location of said sensing device relative to the interior surface of the rotor blade.

19. The method of claim 15, wherein said sensing device comprises a camera, further comprising remotely controlling said camera as said camera is moved within the rotor blade.

20. The method of claim 15, further comprising determining a vertical location of said sensing device along the span of the rotor blade.
